(19) United States
(12) Patent Application Publication
(10) Pub. No.: US 2007/0256095 A1
(43) Pub. Date: Nov. 1, 2007

(54) System and method for the normalization of advertising metrics

(76) Inventor: Robert J. Collins, Carlsbad, CA (US)

Correspondence Address: THELEN REID BROWN RAYSMAN & STEINER LLP, PO BOX 1510, 875 Third Avenue, 8th Floor, NEW YORK, NY, 10150-1510, US

(21) Appl. No.: 11/414,684

(22) Filed: Apr. 27, 2006

(51) Int. Cl. H04N 7/025; H04N 7/10

(52) U.S. Cl. 725/34; 725/35; 725/32

(57) ABSTRACT

The present invention relates to systems and methods for normalizing analytics data corresponding to one or more advertising metrics for one or more advertisements within a group of advertisements. The method of the present invention comprises receiving analytics data corresponding to one or more advertising metrics for one or more advertisements within a group of advertisements. The analytics data corresponding to the one or more advertising metrics for the one or more advertisements is normalized. The normalized analytics data is used to calculate one or more normalized advertising metric values for the one or more advertisements within the group.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention generally provides methods and systems for the normalization of advertising metrics. More specifically, the present invention provides methods and systems for facilitating the normalization of analytics data corresponding to one or more advertising metrics for one or more advertisements.

Advertisements are commonly used on the Internet to promote various products and services. Advertisements may comprise banner ads, links to web pages, images, video, text, etc. The various advertisements used to promote products on the Internet may be displayed according to a variety of formats, such as in conjunction with a ranked result set in response to a query, embedded in a web page, a pop-up, etc. The advertisements displayed to a user of a client device may be selected, redirecting the user to a website providing the product or service advertised.

Client devices, communicatively coupled to a network such as the Internet, are capable of accessing various websites that may display advertisements. For example, a user of a client device may submit a search query comprising one or more terms to a search engine, which causes the search engine to retrieve a result set comprising links to content, as well as advertisements responsive to the search terms provided by a user. The search engine displays the result set that it generates to a user who may then select or view items in the result set, including one or more advertisements.

Advertisements displayed in response to a user's query, which may be embedded within a web page, displayed as a pop-up, etc., are often retrieved according to a predetermined algorithm. For example, the advertisements presented to a user may be selected according to an algorithm that determines the frequency with which a query term appears in a given web advertisement. Similarly, the advertisements embedded in a web page may be selected based upon the terms appearing in the respective web page.

Retrieval and delivery methodologies for advertisements using query term frequency or web page content are tailored to provide users with advertisements based upon each advertisement's relevancy with respect to a query or web page. However, while such retrieval and delivery methods are capable of providing users with links to relevant content, these methods fail to take into account the factors associated with the effectiveness of a given advertisement. Because users may be more responsive to a particular advertisement among a plurality of advertisements pertaining to a similar product or service, the advertiser may desire to obtain information identifying the most successful advertisements in order to increase the likelihood that users purchase the advertiser's products or services.

One methodology for measuring the effectiveness of an advertisement utilizes “click through rate,” which is a measure of the number of users who select a given advertisement. Similarly, effectiveness of a given advertisement may be measured by identifying the number of purchases that result from selection of the advertisement (“conversion rate”). Further, the effectiveness of a given advertisement may be measured according to other metrics, such as by identifying the number of users that browse an advertiser's website in response to the advertisement (“browser rate”).

Raw data regarding advertising metrics fails to adequately measure the success or effectiveness of a given advertisement when compared with a set of advertisements because advertisements may be delivered in a ranked result set, at varying times, to different web pages, etc. For example, a user is more likely to select an advertisement or other item of content ranked and displayed first in a result set or displayed during peak hours of Internet traffic than an item ranked second, third, etc., or displayed during off-peak hours. Similarly, an advertisement displayed during peak hours of Internet traffic is more likely to result in a user browsing an advertiser's website or making a purchase. Therefore, an advertisement ranked first in a result set or appearing during peak hours may often receive the greatest user response, thereby resulting in the greatest click through rate, purchase rate, browsing rate, etc., for a group of advertisements. Simply using raw click through rates, purchase rates, browsing rates, etc., as a measure of effectiveness does not provide a search engine or advertiser with an accurate representation of the success of a given advertisement.

In order to overcome shortcomings associated with existing advertisement performance measurement techniques, embodiments of the present invention provide systems and methods for normalizing analytics data corresponding to one or more advertising metrics for one or more advertisements within a group. Normalized analytics data corresponding to one or more advertising metrics may be used to determine optimal advertisements within a group of advertisements.

### SUMMARY OF THE INVENTION

The present invention is directed towards methods and systems for normalizing analytics data corresponding to one or more advertising metrics for one or more advertisements. The method of the present invention comprises receiving analytics data corresponding to one or more advertising metrics for one or more advertisements within a group of advertisements. Receiving analytics data corresponding to one or more advertising metrics may comprise receiving click through analytics data for one or more advertisements within a group of advertisements or receiving analytics data indicating the purchase of a product associated with a given advertisement. Receiving analytics data corresponding to one or more advertising metrics may also comprise receiving analytics data indicating a user has browsed an advertiser's website in response to a given advertisement or receiving analytics data indicating the provider of a given advertisement displayed to a user.

The analytics data corresponding to the one or more advertising metrics for the one or more advertisements is normalized according to a selected normalizing algorithm. The normalizing algorithm may be selected based upon the analytics data received for the one or more advertisements, the type of advertisements within the group of advertisements, the quantity of analytics data received for the one or more advertisements, or the one or more advertising metrics to be normalized for the one or more advertisements. The analytics data corresponding to the one or more advertising metrics for the one or more advertisements may be normalized with respect to time or with respect to the position of the one or more advertisements in a ranked list of advertisements. According to one embodiment of the invention, an empirical body of data is used to normalize the analytics data, wherein an empirical body of data comprises data indicating the likelihood of an occurrence of an event associated with a given advertising metric.

One or more normalized advertising metric values are calculated for the one or more advertisements using the normalized analytics data corresponding to one or more advertising metrics. According to one embodiment of the invention, the method further comprises selecting one or more advertisements from among the group of advertisements for distribution according to the one or more normalized advertising metric values associated with the one or more advertisements and distributing the one or more selected advertisements. The one or more advertisements selected for distribution may comprise advertisements with one or more normalized advertising metric values exceeding a given threshold. Tracking codes may be generated for the one or more advertisements selected for distribution that provide analytics data that correspond to the one or more advertising metrics. The advertisements selected for distribution may be distributed to a website or one or more advertisement providers. Alternatively, or in conjunction with the foregoing, the one or more advertisements selected for distribution may be distributed as pop-up advertisements, as banner advertisements, or in response to a user search request.

The present invention is also directed towards a system for normalizing analytics data corresponding to one or more advertising metrics for one or more advertisements. The system of the present invention comprises a content data store operative to store one or more advertisements. The content data store is operative to store one or more advertisements in one or more groups, wherein a group of advertisements comprises one or more advertisements directed at selling a similar product or services, or advertisements associated with a given advertiser. An analytics data store is operative to store analytics data associated with the one or more advertisements stored in the content data store, such as analytics data associated with one or more advertising metrics.

The system further comprises a normalizing component operative to retrieve analytics data corresponding to one or more advertising metrics for the one or more advertisements in the content data store. The normalizing component normalizes the analytics data corresponding to the one or more advertising metrics for the one or more advertisements according to a selected normalizing algorithm. The normalizing component is further operative to calculate one or more normalized advertising metric values for the one or more advertisements using the selected normalizing algorithm and an empirical body of data indicating the likelihood of an occurrence of an event associated with a given advertising metric.

According to one embodiment, the system comprises a content distribution component operative to select one or more of the advertisements for distribution. The advertisements selected for distribution may be selected based upon one or more normalized advertising metric values. The content distribution component is further operative to generate tracking codes that identify analytics data corresponding to one or more advertising metrics for the one or more advertisements selected for distribution and distribute the one or more selected advertisements with associated tracking codes. The content distribution component may distribute the advertisements with associated tracking codes to one or more web sites or advertisement providers. Additionally, the content distribution component may distribute the advertisements as pop-up advertisements or in response to one or more user search requests.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for receiving and normalizing analytics data corresponding to one or more advertising metrics for or more advertisements according to one embodiment of the present invention;

FIG. 2 is a flow diagram presenting a method for normalizing analytics data corresponding to one or more advertising metrics for one or more advertisements according to one embodiment of the present invention;

FIG. 3 is a flow diagram presenting a method for distributing optimal advertisements from among a group of advertisements and receiving analytics data for one or more advertisements according to one embodiment of the present invention; and

FIG. 4 is a flow diagram presenting a method for generating one or more reports identifying optimal advertisements from among a group of advertisements using normalized advertising analytics data corresponding to one or more advertising metrics according to one embodiment of the present invention.

### DETAILED DESCRIPTION OF THE PREFERRED EMBODIMENT

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

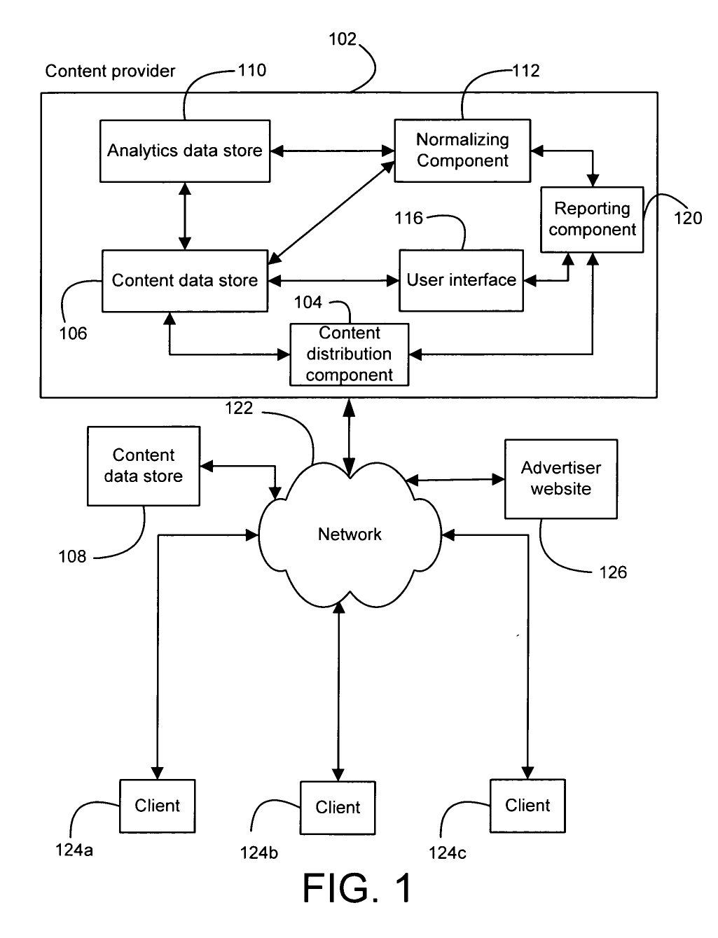

FIG. 1 presents a block diagram depicting one embodiment of a system for receiving and normalizing analytics data corresponding to one or more advertising metrics for one or more advertisements. According to the embodiment of FIG. 1, client devices 124a, 124b and 124c are communicatively coupled to a network 122, which may include a connection to one or more local and/or wide area networks, such as the Internet. According to one embodiment of the invention, a client device 124a, 124b and 124c is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Client devices 124a, 124b and 124c communicatively coupled to a network 122 may transmit search requests to a content provider 102 and receive a plurality of advertisements in response to the respective requests. Similarly, client devices may access web sites with embedded advertisements delivered from the content provider 102, receive advertisements as pop-up ads from the content provider 102, etc. The advertisements displayed to client devices 124a, 124b and 124c are stored in and retrieved from one or more local or remote content data stores 106 and 108.

Local or remote content data stores 106 and 108 are operative to maintain one or more advertisements and may comprise one or more accessible memory structures such as a database, CD-ROM, tape, digital storage library, etc. The content data stores 106 or 108 may be implemented as databases or any other type of storage structures capable of providing for the retrieval and storage of a variety of data types. The content data stores 106 and 108 may store a variety of advertisement data types including websites, text, video, images, banners, links, etc. Advertisements maintained in content data stores 106 and 108 may be maintained in groups according to advertiser, product, category, or a combination thereof. Exemplary methods for maintaining one or more advertisements in one or more groups are described in commonly owned patent application entitled “SYSTEM AND METHOD FOR ADVERTISEMENT MANAGEMENT,” filed on Dec. 31, 2005, the disclosure of which is hereby incorporated by reference in its entirety.

According to one embodiment, advertisements are stored in content data stores 106 and 108 in groups according to a given product or service offered by a given advertiser. According to another embodiment of the invention, advertisements are stored in content data stores 106 and 108 in groups according to the time of the day the advertisements are distributed. Those of skill in the art recognize other methods for storing one or more advertisements in one or more groups.

Advertisers communicatively coupled to the network 122 may access the content data stores 106 and 108 via the content provider 102 user interface 116. The user interface 116 provides an advertiser with the ability to view existing advertisements in content data stores 106 and 108, add new advertisements, modify existing advertisements, remove existing advertisements, create new groups of advertisements, etc. The user interface 116 may further provide an advertiser with the ability define advertiser preferences with respect to one or more advertisement groups. For example, an advertiser may specify a classification for a given advertisement or may define threshold values used in determining the frequency with which to distribute an advertisement. The user interface 116 may be a graphical user interface, a command line interface or other similar interface known to those of skill in the art.

A content distribution component 104 retrieves advertisements from content data stores 106 and 108 and generates tracking codes for the advertisements retrieved. The tracking codes generated by the content distribution component 104 allow the content provider 102 to maintain information corresponding to one or more advertising metrics for one or more advertisements. According to one embodiment of the invention, tracking codes are placed in the destination URL for the one or more advertisements retrieved by the content distribution component 104 for one or more advertising metrics identified by the content provider 102.

According to another embodiment of the invention, the content distribution component 104 generates tracking codes based upon the type of advertisements retrieved from content data stores 106 and 108. For example, the content distribution component 104 may generate tracking codes for a pop-up advertisement that retrieve information on the number of users that selected the advertisement, whereas the content distribution component 104 may generate tracking codes for a banner advertisement that identifies the number of times the advertisement was displayed to users of client devices 124a, 124b and 124c by a given advertisement provider, such as a search engine. According to yet another embodiment of the invention, the content distribution component 104 generates tracking codes based upon advertiser specified information indicating the one or more advertising metrics a given advertiser wishes to monitor. For example, an advertiser may utilize the content provider 102 user interface 116 to specify that the advertiser wishes to receive information on the number of users that purchased a product in response to a given advertisement, the number of users that browsed an advertiser's web page in response to an advertisement, etc. The content distribution component 104 may generate tracking codes for the one or more advertiser specified advertising metrics.

The content distribution component 104 distributes the one or more advertisements retrieved from content data stores 106 and 108 to one or more destinations in one or more formats. According to one embodiment of the invention, the content distribution component 104 distributes the advertisements retrieved from content data stores 106 and 108 to one or more advertiser web sites 126. According to another embodiment of the invention, the content distribution component 104 distributes the one or more advertisements as pop-up advertisements. According to a further embodiment of the invention, the content distribution component 104 distributes the one or more advertisements to one or more affiliate web pages based upon, for example, the content of the affiliate web page. According to yet another embodiment of the invention, the content distribution component 104 distributes the one or more advertisements in response to one or more search queries submitted to a search engine. The one or more advertisements distributed by the content distribution component 104 are displayed on one or more client devices 124a, 124b and 124c.

A user may interact with the one or more advertisements displayed on the given user's client device 124a, 124b and 124c. For example, a user may select a given advertisement displayed on the user's client device 124a, 124b and 124c. The tracking codes associated with the advertisements distributed by the content distribution component 104 allow the content provider 102 to maintain information on one or more advertising metrics, wherein an advertising metric may comprise the number of users who selected an advertisement, the number of purchases that resulted from a given advertisement, the number of users who browsed an advertiser's web site in response to a given advertisement, etc.

According to one embodiment of the invention, tracking codes are placed in the destination URL for the one or more advertisements maintained by the content provider 102. For example, the one or more advertisements maintained in the content provider 102 may have associated destination URLs that may be selected by users of client devices 124a, 124b and 124c. Tracking codes for a given advertisement may be placed in the destination URL associated with the advertisement. Upon selection of the advertisement by a user of a client device 124a, 124b and 124c, data indicating the selection of the given advertisement may be delivered to the content provider 102 and maintained in the analytics data store 110. Thereafter, an HTTP redirect request may be delivered via the network 122 to the user's client device 124a, 124b and 124c, redirecting the user to the destination URL associated with the advertisement selected. The tracking codes placed in the destination URL may provide analytics data to the content provider 102 for one or more advertising metric events associated with an advertisement.

The tracking codes associated with a given advertisement may also utilize or incorporate tags contained within a given advertiser's website to gather information corresponding to one or more advertising metrics for delivery to the analytics data store 110. For example, tags contained within an advertiser's one or more web pages may indicate whether the web page is associated with purchasing, browsing, etc. The information provided by the tags contained in an advertiser's one or more web pages may be included with the tracking codes associated with a given advertisement to deliver analytics data to the analytics data store 110 via the network 122. The information associated with an advertiser's web site and delivered to the analytics data store 110 may comprise the advertisement selected, the time of day, information stored in a user profile, the ranking of the advertisement in a ranked list of advertisements, the plurality of web pages viewed by the user on the advertiser's web site, the products purchased by the user from the advertiser's website, etc.

The analytics data store 110 is an accessible memory structure such as a database, CD-ROM, tape, digital storage library, etc. The analytics data store 110 maintains analytics data associated with user interactions with advertisements and may be implemented as a database or any other type of data storage structure capable of providing for the retrieval and storage of a variety of data types. The analytics data store 110 may store a variety of data types related to advertisements. Advertisement information in the analytics data store 110 may be maintained in groups according to advertiser, product, category, advertising metric, or a combination thereof. Advertisement information in the analytics data store 110 may also be maintained according to advertiser specified groups, as is described in commonly owned patent application entitled “SYSTEM AND METHOD FOR ADVERTISEMENT MANAGEMENT,” filed on Dec. 31, 2005, the disclosure of which is hereby incorporated by reference in its entirety.

The analytics data store 110 is periodically populated with analytics data indicating user interactions with advertisements, which may also include interactions with an advertiser web site 126. Using tracking codes, the analytics data store 110 receives analytics data associated with a given advertisement and determines whether an existing record exists for the analytics data received. If the analytics data store 110 locates a record, the analytics data store 110 updates the existing record to indicate further user interactions with a given advertisement or advertiser web site 126. For example, if the analytics data store 110 receives information indicating that a user of a client device 124a, 124b and 124c selected a given advertisement, the analytics data store 110 determines whether a record exists for the given advertisement. If a record exists, the record is updated to indicate that an additional user selected the given advertisement. If a record does not exist corresponding to the information received, a new entry is created in the analytics data store 110 for the given advertisement's information.

The normalizing component 112 normalizes the analytics data corresponding to one or more advertising metrics for one or more advertisements maintained in content data stores 106 and 108. The normalizing component 112 retrieves analytics data corresponding to one or more advertising metrics from the analytics data store 110. The normalizing component 112 utilizes a normalization algorithm to normalize the analytics data associated with advertisements in a group of advertisements and to calculate one or more normalized advertising metric values for the one or more advertisements in the group. The normalization algorithm utilized by the normalizing component 112 normalizes differences for a given advertising metric due to one or more variables associated with the advertising metric. For example, the normalizing algorithm may normalize analytics data indicating the selection of one or more advertisements with respect to the position of the one or more advertisements in a ranked list of advertisements. Similarly, the normalizing algorithm may normalize analytics data indicating the selection of one or more advertisements with respect to the time of day the one or more advertisements were displayed.

According to one embodiment of the invention, the normalizing component 112 selects an algorithm based upon the type of analytics data to be normalized. According to another embodiment of the invention, the normalizing component 112 selects an algorithm to normalize the analytics data associated with one or more advertisements in a group of advertisements based upon the quantity of analytics data available for the one or more advertisements. According to yet another embodiment of the invention, the normalizing component 112 selects an algorithm to normalize the analytics data associated with one or more advertisements in a group of advertisements based upon the quantity of advertisements in the group.

The normalizing component 112 may be configured to periodically normalize the analytics data corresponding to one or more advertising metrics for advertisements stored in content data stores 106 and 108. For example, the normalizing component 112 may be configured to calculate normalized advertising metric values for the one or more advertisements in a group once every 24 hours, once a week, etc. Furthermore, the normalizing component 112 may be configured to execute a normalization algorithm until the normalizing component 112 has determined the N most effective advertisements in a given group for one or more advertising metrics, where N may be a threshold defined by the content provider or defined by an advertiser using the user interface 116 of the content provider 102. Additionally, the normalizing component 112 may be configured to execute a normalization algorithm upon receipt of new advertisements from an advertiser or upon detecting the removal of an advertisement by an advertiser from content data stores 106 and 108.

The normalized advertising metric values associated with the one or more advertisements in a group of advertisements that the normalizing component 112 generates are stored in content data stores 106 and 108 with corresponding advertisements. The content distribution component 104 utilizes the normalized advertising metric values associated with one or more advertisements in a given group of advertisements to determine which advertisements to distribute in response to a request. When the content provider 102 receives a request, the content distribution component 104 retrieves one or more groups of advertisements from content data stores 106 and 108 in response to the request. The content distribution component 104 may analyze the normalized advertising metric values for the one or more advertisements in the one or more groups of advertisements retrieved from content data stores 106 and 108.

According to one embodiment of the invention, the content distribution component 104 selects the one or more advertisements with normalized advertising metric values exceeding a given threshold for one or more advertising metrics for display to users of client devices 124a, 124b and 124c. Therefore, users of client devices 124a, 124b and 124c receive advertisements from a group comprising one or more advertisements that have greater normalized advertising metric values for one or more advertising metrics, thereby increasing the likelihood that a given advertisement is selected, results in a user browsing an advertiser's website, results in a purchase, etc.

The system illustrated in FIG. 1 may further be used to generate one or more reports indicating the normalized performance of one or more advertisements within a group of advertisements. According to one embodiment of the invention, advertisement providers, such as Yahoo!, AOL or MSN, may distribute advertisements with tracking codes in order to gather analytics data corresponding to one or more advertising metrics. The analytics data may be delivered to the content provider 102 and maintained in the analytics data store 110.

The content provider 102 utilizes the normalizing component 112 to normalize the analytics data corresponding to one or more advertising metrics maintained in the analytics data store 106. The reporting component 120 utilizes the normalized analytics data to generate one or more reports that may be delivered to advertisement providers communicatively coupled to the content provider 102. The one or more reports generated by the reporting component 120 may identify the normalized performance of one or more advertisements in a group of advertisements for one or more advertising metrics.

According to one embodiment of the invention, reports generated by the reporting component 120 may be periodically delivered to advertisement providers to facilitate the optimal distribution of advertisements. For example, a report may indicate the one or more advertisements in a given group of advertisements that have a normalized purchase rate exceeding a given threshold. Similarly, a report may indicate the one or more advertisements in a group of advertisements that have a normalized click through rate exceeding a given threshold. The advertisement providers that receive the reports may utilize the normalized analytics data corresponding to one or more advertising metrics to determine the distribution of advertisements. For example, an advertisement provider may distribute the one or more advertisements with a normalized click through rate exceeding a given threshold or the N advertisements with the greatest normalized click through rate.

According to another embodiment of the invention, advertisers may utilize the content provider 102 user interface 116 to request one or more reports identifying the normalized performance of one or more advertisements in a group of advertisements. An advertiser may utilize the information reflected in a report generated by the reporting component 120 to modify the advertiser's advertising strategy. For example, a report may indicate the normalized click through rate of one or more advertisements during a given time period. The report may further indicate the normalized rate of the number of users who browsed the advertiser's website in response to one or more advertisements. The report may also indicate the normalized rate of the number of users who viewed the advertiser's website from one or more search providers, such as Yahoo!, AOL, Google, etc.

An advertiser may utilize information reflected in a report to formulate an advertising strategy for one or more advertisements within a group of advertisements. For example, if a report indicates that the normalized rate of users arriving at the advertiser's website from the Yahoo! search engine is significantly greater than the normalized rate of users arriving at the advertiser's website from the Google search engine, the advertiser may wish to increase the number of advertisements displayed to users of the Yahoo! search engine and decrease the number of advertisements displayed to users of the Google search engine. Similarly, in a bidding marketplace, an advertiser may choose to increase the bid associated with an advertisement receiving a higher normalized click through rate and decrease the bid associated with an advertisement receiving a lower normalized click through rate. Those of skill in the art recognize the plurality of uses of a report indicating the normalized performance of one or more advertisements for one or more advertising metrics.

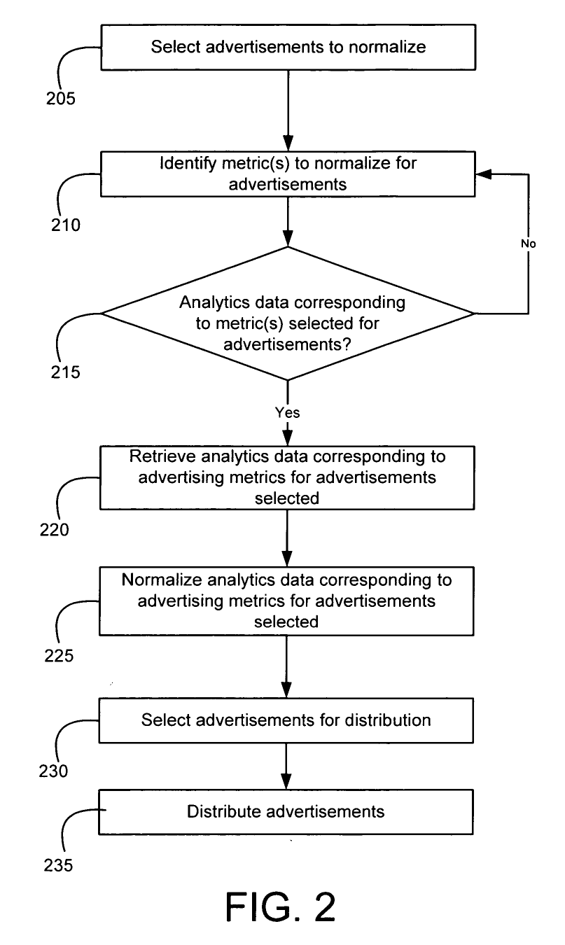

FIG. 2 presents a flow diagram illustrating one embodiment of a method for normalizing analytics data corresponding to one or more advertising metrics for one or more advertisements. A group of advertisements is selected for normalization from the one or more groups of advertisements stored in one or more content data stores, step 205. The one or more advertising metrics to be normalized for the one or more groups of advertisements are selected, step 210. According to one embodiment of the invention, an advertising metric comprises an event associated with one or more user interactions with a given advertisement. For example, an advertising metric may comprise the number of users who selected a given advertisement or the number of users who browsed an advertiser's website in response to a given advertisement. An advertising metric may also comprise the number of users who purchased products from a given advertiser in response to a given advertisement. Alternatively, or in conjunction with the foregoing, an advertising metric may comprise the number of users who selected a given advertisement displayed by a given advertisement provider. Those of skill in the art recognize the plurality of advertising metrics that may be identified for a given group of advertisements.

According to one embodiment of the invention, the one or more advertising metrics selected for normalization may comprise advertiser selected advertising metrics. For example, an advertiser may specify the one or more advertising metrics to normalize for one or more groups of advertisements. According to another embodiment of the invention, the one or more advertising metrics selected for normalization are based upon the type of advertisements selected. For example, the advertising metric selected for normalization for banner advertisements may comprise the number of times the advertisement was displayed to users of client devices, whereas the advertising metric selected for normalization for pop-up advertisements may comprise the number of users that selected the pop-up advertisements.

A check is performed to determine whether analytics data is available for the one or more advertising metrics selected for the one or more groups of advertisements, step 215. If analytics data is not available for the one or more advertising metrics selected, step 215, alternate advertising metrics are selected, step 210. Alternatively, if analytics data is available for the selected advertising metrics, the analytics data is retrieved, step 220.

According to one embodiment of the invention, the analytics data corresponding to the one or more advertising metrics for the one or more advertisements is retrieved from an analytics data store, step 220. The analytics data may comprise information indicating the number of times a given advertisement was selected by users when displayed in a certain position within a ranked list of advertisements, the time of day an advertisement was displayed, characteristics of a user who selected the advertisement (which may be specified in a user profile), etc. The analytics data corresponding to the advertising metrics selected is used to generate one or more normalized advertising metric values for the one or more advertisements comprising the group of advertisements. For example, a group of advertisements from a given advertiser may comprise one or more advertisements directed at advertising “wireless routers.” The analytics data store may contain analytics data indicating the number of times each advertisement in the “wireless router” advertisement group was selected.

According to one embodiment, a normalizing component is used to normalize analytics data corresponding to one or more advertising metrics for the one or more advertisements comprising a group of advertisements, step 225. The normalized analytics data corresponding to one or more advertising metrics for the one or more advertisements may be used to generate one or more normalized advertising metric values for the one or more advertisements. For example, the normalized analytics data may be used to generate a normalized click through rate for a given advertisement, a normalized browser rate for a given advertisement, a normalized conversion rate for a given advertisement, etc.

The process of normalizing analytics data associated with one or more advertisements may be performed using a normalizing algorithm, an empirical body of data, and the data retrieved from the analytics data store. The normalization process is performed to normalize differences for a given advertising metric due to one or more variables. For example, the normalization process for a click through rate advertising metric may be performed to normalize differences in click through rates due to advertisements appearing in different positions within a ranked result set, as advertisements appearing first in a ranked result set are more likely to be selected by a user than advertisements appearing second, third, etc. Similarly, the normalization process for a click through rate advertising metric may be performed to normalize differences in click through rates due to advertisements appearing at different times of the day, different days of the week, etc. For example, advertisements appearing at 9:00 a.m. or 7:00 p.m. may receive a greater click through rate than advertisements appearing at 4:30 a.m. or 11:00 p.m. Therefore, advertisements appearing during different time periods may be normalized according to time to compare the effectiveness of one or more advertisements in a given group of advertisements.

The normalizing algorithm used to normalize analytics data for one or more advertising metrics may utilize an empirical body of data. According to one embodiment of the invention, an empirical body of data for a given advertising metric comprises an indication of the likelihood of the occurrence a given event associated with the advertising metric. The empirical body of data utilized the by normalizing algorithm may comprise information associated with one or more advertisements in one or more groups of advertisements. Alternatively, or in conjunction with the foregoing, the empirical body of data utilized by the normalizing algorithm may comprise information associated with one or more advertisements other than the one or more advertisements in the selected group of advertisements being normalized.

For example, a normalizing algorithm, illustrated in Table A below, may be used to normalize click through rate analytics data to indicate the normalized likelihood of a given advertisement being selected when displayed in a ranked list of advertisements. As previously noted, advertisements appearing first in a ranked list of advertisements are more likely to be selected by a user than advertisements appearing second, third, etc. Therefore, an advertisement appearing first in a ranked result set may have a significantly greater click through rate than an advertisement appearing second, third, etc.

A normalization of the click through rate analytics data, using empirical data, compensates for the difference in rank positions of the one or more items comprising a group of advertisements. The empirical data used by the selected normalization algorithm may provide information specifying the likelihood of an advertisement being selected by a user when displayed in position one, two, three, etc., of a ranked group of advertisements. Similarly, an empirical body of data may be used by a normalizing algorithm to provide information specifying the likelihood of an advertisement resulting in a purchase when displayed by a given advertisement provider, such as Yahoo! or MSN.

Table A presents one embodiment of equations that may be used to compute a normalized advertising metric value for a given advertisement. The equations illustrated in Table A provide for the calculation of a normalized click through rate value for a given advertisement. Those of skill in the art recognize that the equations illustrated in Table A may be modified so as to provide for the calculation of other advertising metric values for a given advertisement.

TABLE A
${I}_{N} = {\sum }_{a , b} {I}_{a , b}$
${C}_{N} = {\sum }_{a , b} \frac{{C}_{a , b}}{{CTRp}_{a} \times {CTRt}_{b}}$
${CTR}_{N} = \frac{{C}_{N}}{{I}_{N}}$

According to the equation presented in Table A, a is the position a given advertisement was displayed or clicked, b is the hour-of-week the given advertisement was displayed or clicked, CTRp is a position-based factor that indicates the relative likelihood of an advertisement being clicked in a particular position. CTRt is a time-based factor that indicates the relative likelihood of an advertisement being clicked at a particular time. I_{a,b} is the number of times the given advertisement was displayed in position a in hour b, C_{a,b} is the number of clicks the given advertisement received in position a in hour b, I_{N} is the normalized number of times the given advertisement was displayed, C_{N} is the normalized number of clicks for the given advertisement, and CTR_{N} is the normalized click-through rate for the given advertisement.

The one or more normalized advertising metric values associated with the one or more advertisements are used to select one or more of the advertisements for distribution, step 230. According to one embodiment of the invention, a content distribution component examines the normalized advertising metric values associated with the one or more advertisements in order to select one or more of the advertisements for distribution.

The content distribution component may utilize a plurality of techniques for selecting advertisements for distribution. According to one embodiment of the invention, the content distribution component selects one or more advertisements for distribution that have one or more normalized advertising metric values exceeding a given threshold. For example, the content distribution component may select advertisements that have both a normalized conversion rate exceeding a given threshold and a normalized click through rate exceeding a given threshold, wherein the one or more thresholds may be identified by an advertiser or identified by the content provider. Similarly, the content distribution component may select the N advertisements with the greatest normalized advertising values for one or more advertising metrics. Those of skill in the art recognize other techniques for selecting one or more advertisements for distribution using normalized advertising metric values.

The one or more advertisements selected for distribution are distributed to one or more destinations in one or more formats, step 235. According to one embodiment of the invention, the one or more advertisements selected for distribution are delivered in response to search requests submitted by users utilizing a search engine. According to another embodiment of the invention, the one or more advertisements selected for distribution are delivered as pop-up advertisements. According to a further embodiment of the invention, the one or more advertisements selected for distribution are embedded in affiliate web pages. According to another embodiment of the invention, the one or more advertisement selected for distribution are delivered to one or more advertisement providers, such as Yahoo!, for distribution to one or more users. Those of skill in the art recognize the plurality of destinations and formats for advertisements that are selected for distribution.

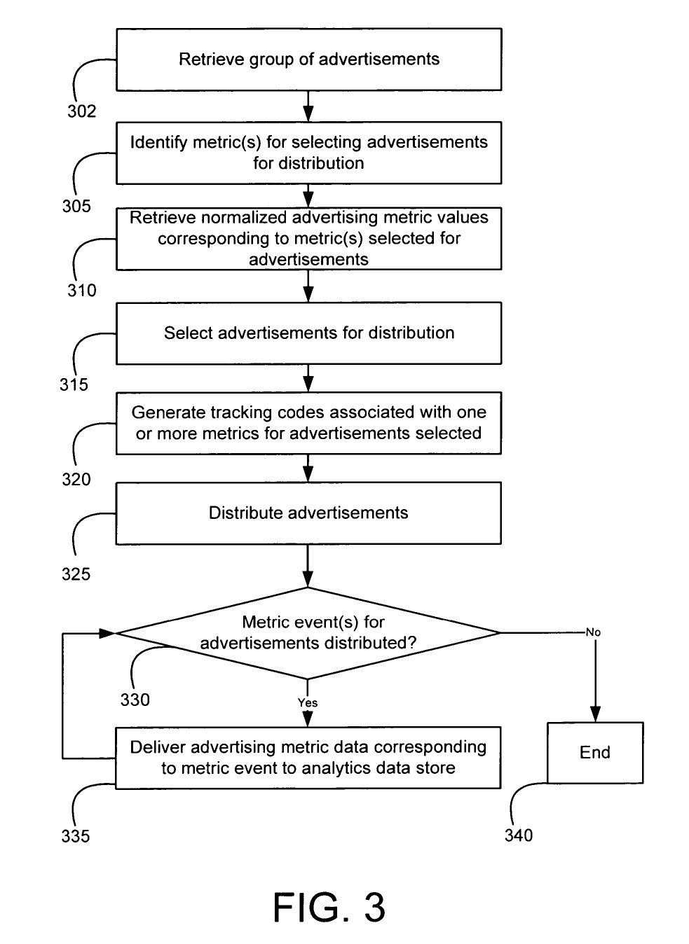

FIG. 3 is a flow diagram illustrating one embodiment of a method for distributing advertisements and receiving analytics data corresponding to one or more advertising metrics for the one or more advertisements distributed. A group of advertisements is retrieved from one or more remote or local content data stores, step 302. One or more advertising metrics are identified for selecting advertisements for distribution, step 305. According to one embodiment of the invention, an advertiser may select the one or more advertising metrics used to select advertisements for distribution. For example, an advertiser may specify that advertisements are to be selected based upon a conversion rate advertising metric. Similarly, an advertiser may specify that advertisements are to be selected based upon a click through rate advertising metric. According to another embodiment of the invention, the one or more advertising metrics are selected based upon the one or more advertisements in a given group of advertisements. For example, a group of advertisements may comprise pop-up advertisements directed at selling notebook computers. A click through rate advertising metric may be used to select advertisements for distribution to increase the likelihood that users select the pop-up advertisements distributed.

Normalized advertising metric values for the one or more identified advertising metrics are retrieved for the one or more advertisements in the group, step 310. The normalized advertising metric values corresponding to the one or more advertisements in the group may be retrieved from one or more content data stores. The one or more normalized advertising metric values corresponding to the one or more advertisements are used to select one or more advertisements for distribution, step 315.

According to one embodiment of the invention, the N advertisements with the greatest normalized advertising metric values for the one or more advertising metrics identified are selected for distribution. For example, an advertiser may identify a normalized click through rate advertising metric and a normalized conversion rate advertising metric for selecting advertisements for distribution. The N advertisements with the greatest normalized click through rates and the N advertisements with the greatest normalized conversion rates may be selected for distribution. According to another embodiment of the invention, one or more normalized advertising metric thresholds may be used to select advertisements for distribution. Advertisements with associated normalized advertising metric values exceeding the threshold value for the one or more advertising metrics are selected for distribution. Those of skill in the art recognize other methods for selecting one or more advertisements from among a group of advertisements for distribution.

Tracking codes are generated for the one or more advertisements selected for distribution, step 320. The tracking codes generated for a given advertisement allow for the collection of analytics data corresponding to one or more advertising metrics. The analytics data associated with a given advertisement may be delivered to an analytics data store, which may maintain analytics data for one or more advertisements. For example, the tracking codes associated with a given advertisement may be used to collect analytics data regarding user interactions with the advertisement, such as a user's selection of the advertisement, the time of day the user selected the advertisement, etc. Similarly, tracking codes may be used to collect information from an advertiser's web site. For example, a user may select an advertisement and be redirected to the corresponding advertiser's website. The user may browse products on the advertiser's website, purchase one or more products, etc. Using tags embedded in the various web pages of an advertiser's website, the tracking codes may identify the one or more products viewed by a given user in response to an advertisement, the web pages viewed by a given user in response to a an advertisement, the products purchased by a given user in response to an advertisement, etc. Those of skill in the art recognize the plurality of data that may be collected using tracking codes.

The one or more advertisements selected for distribution may be distributed to one or more destinations in one or more formats, step 235. For example, the one or more advertisements selected for distribution may be delivered in response to search requests submitted by users utilizing a search engine or as pop-up advertisements. Alternatively, the one or more advertisements selected for distribution may be embedded in one or more affiliate web pages. The one or more advertisement selected for distribution may also be delivered to one or more advertisement providers, such as Yahoo!, for distribution to one or more users. Those of skill in the art recognize the plurality of destinations and formats for advertisements that are selected for distribution.

The one or more advertisements selected for distribution and the tracking codes associated with the one or more advertisements are distributed, step 325. For example, the one or more advertisements selected for distribution may be delivered in response to search requests submitted by users utilizing a search engine or as pop-up advertisements. Alternatively, the one or more advertisements selected for distribution may be delivered to one or more web pages as banner advertisements, or embedded in one or more affiliate web pages. The one or more advertisements selected for distribution may also be delivered to one or more advertisement providers, such as Yahoo!, for distribution to one or more users. Those of skill in the art recognize the plurality of destinations and formats for advertisements that are selected for distribution.

The tracking codes associated with the one or more distributed advertisements are used to monitor the one or more advertisements to identify an advertising metric event associated with a given advertisement, step 330. According to one embodiment of the invention, an advertising metric event comprises a user interaction with an advertisement. For example, a user's selection of an advertisement, using a selection device such as a mouse or a keyboard, may comprise a click through advertising metric event. Similarly, a user's purchase of a product from a given advertiser's website may comprise a conversion advertising metric. Further, a user browsing an advertiser's web site in response to a given advertisement may comprise a browsing advertising metric.

If no advertising metric events associated with the one or more advertisements are identified, analytics data is not delivered to the analytics data store, step 340. Alternatively, if an advertising metric event is identified, step 330, the data associated with the advertising metric event is retrieved and delivered to an analytics data store, step 335. The tracking codes associated with a given advertisement may be used to identify an advertising metric event associated with the advertisement. For example, a user's selection of an advertisement may result in the user being redirected to the corresponding advertiser's website. The user's selection of the advertisement may be identified as a click through advertising metric event, and data regarding the selection of the advertisement, such as the advertisement selected, the time the advertisement was selected, etc., may be delivered to an analytics data store. Thereafter, the user may visit a purchasing web page on the advertiser's web site and purchase a product. The tracking codes associated with the advertisement selected may be utilized to identify information maintained on the advertiser's purchasing web page, such as tags, in order identify information regarding the user's purchase of a product from the purchasing web page. The data gathered from the tracking codes associated with the advertisement selected may thereafter be delivered to the analytics data store.

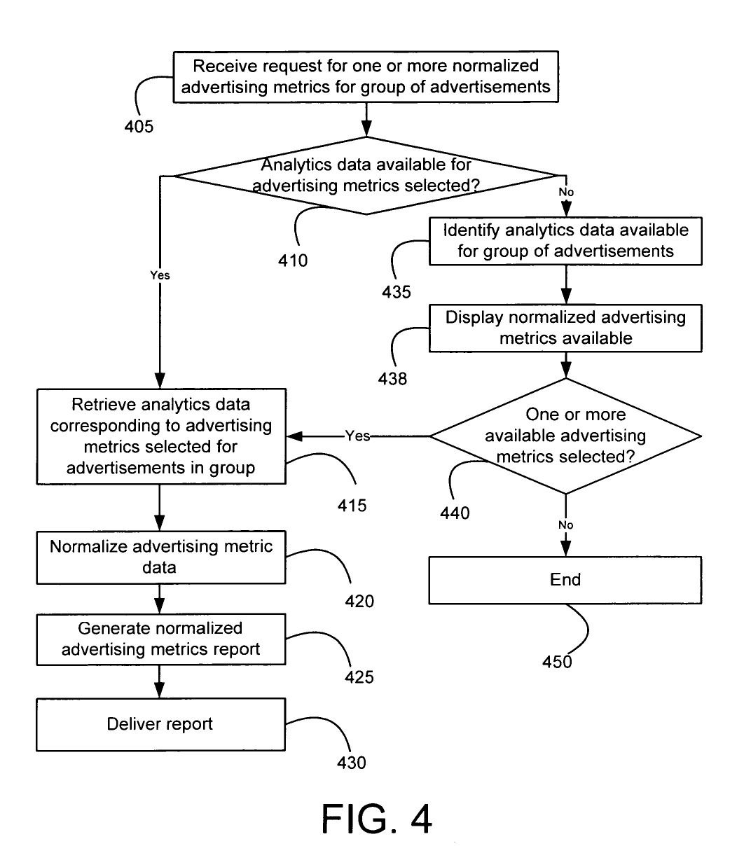

As discussed above, embodiments of the present invention may be used to generate one or more reports indicating the normalized performance of one or more advertisements using normalized advertising metrics. FIG. 4 is a flow diagram illustrating a method for generating one or more reports indicating the normalized performance of one or more advertisements using normalized advertising metrics. A request is received for normalized analytics data corresponding to one or more advertising metrics for a given group of advertisements, step 405. According to one embodiment of the invention, an advertiser or advertisement provider may deliver a request via a client device communicatively coupled to the content provider illustrated in FIG. 1.

A check is performed to determine whether analytics data is available corresponding to the advertising metrics requested for the one or more advertisements in the group, step 410. For example, a request for normalized conversion rates for one or more advertisements in a group of advertisements may be received. The content provider may inspect the analytics data store to determine whether conversion rate analytics data is available for the one or more advertisements in the group of advertisements. If analytics data is available for the one or more advertising metrics and advertisements selected, the analytics data is retrieved, step 415.

If analytics data is not available for the one or more normalized advertising metrics requested, a search is performed to identify the analytics data available for the one or more advertisements in the group of advertisements, step 435. For example, a request may be received for normalized conversion rates for one or more advertisements in a group of advertisements. The content provider may determine that conversion rate analytics data for the one or more advertisements in the group of advertisements is not available. The content provider may determine, however, that click through rate analytics data is available for the one or more advertisements. The analytics data available for the one or more advertisements in a group may be used to identify the normalized advertising metric values that may be calculated for the one or more advertisements in the group.

The one or more normalized advertising metric values that may be calculated for the group of advertisements are displayed to the advertiser or advertisement provider, step 438, allowing the advertiser or advertisement provider to select one or more alternate advertising metrics. For example, a graphical user interface may be used to display the one or more normalized advertising metric values that may be generated for a given group of advertisements. A check is performed to determine whether any of the one or more advertising metric values that may be calculated for the group of advertisements are selected, step 440. If none of the advertising metrics are selected, processing ends, and a report is not generated for the group of advertisements, step 450. Alternatively, if one or more of the advertising metrics are selected, the corresponding analytics data is retrieved, step 415.

The analytics data retrieved is normalized using a normalizing algorithm, step 420. According to one embodiment of the invention, a normalization algorithm is selected based upon the one or more advertising metrics requested. For example, a click through rate normalization algorithm may be selected for normalizing analytics data associated with click through analytics data, whereas a conversion rate normalization algorithm may be selected for normalizing analytics data associated with conversion analytics data. According to another embodiment of the invention, a normalization algorithm is selected based upon the type of advertisements comprising the group of advertisements.

The normalized analytics data is used to generate one or more reports indicating the normalized performance of the one or more advertisements in the group for the one or more advertising metrics selected, step 425. The one or more reports generated may be delivered to an advertiser or advertisement provider, step 430. For example, a report may be delivered to an advertiser and utilized by the advertiser to formulate or modify an advertising strategy. Based upon the normalized analytics data reflected in a report, an advertiser may modify a bid associated with a given advertisement, remove one or more advertisements from a group of advertisements, etc.

Similarly, a report may be delivered to an advertisement provider, such as Yahoo! or MSN. An advertisement provider may utilize the report to determine the optimal advertisements to distribute in response to user requests. For example, an advertisement provider may choose to distribute the N advertisements that receive the greatest normalized click through rate or the N advertisements exceeding a given threshold, as indicated in the report, to maximize the likelihood that advertisements are selected. Similarly, the advertisement provide may choose to distribute the N advertisements with the greatest normalized conversion rates, as indicated in the report, to maximize the likelihood that users purchase one or products. Those of skill in the art recognize the plurality of techniques that may be used to formulate an advertising strategy or select advertisements for distribution based upon normalized analytics data corresponding to one or more advertising metrics in a given report.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

We claim:

1. A method for normalizing analytics data corresponding to one or more advertising metrics for one or more advertisements, the method comprising:
receiving analytics data corresponding to one or more advertising metrics for one or more advertisements within a group of advertisements;
normalizing the analytics data corresponding to the one or more advertising metrics for the one or more advertisements according to a selected normalizing algorithm; and
calculating one or more normalized advertising metric values for the one or more advertisements.

2. The method of claim 1 wherein receiving analytics data corresponding to one or more advertising metrics comprises receiving click through analytics data for one or more advertisements within a group of advertisements.

3. The method of claim 1 wherein receiving analytics data corresponding to one or more advertising metrics comprises receiving analytics data indicating the purchase of a product associated with a given advertisement.

4. The method of claim 1 wherein receiving analytics data corresponding to one or more advertising metrics comprises receiving analytics data indicating a user has browsed an advertiser's website in response to a given advertisement.

5. The method of claim 1 wherein receiving analytics data corresponding to one or more advertising metrics comprises receiving analytics data indicating the provider of a given advertisement displayed to a user.

6. The method of claim 1 wherein a selected normalizing algorithm comprises an algorithm selected based upon the analytics data received for the one or more advertisements within the group of advertisements.

7. The method of claim 1 wherein a selected normalizing algorithm comprises an algorithm selected based upon the type of advertisements within the group of advertisements.

8. The method of claim 1 wherein a selected normalizing algorithm comprises an algorithm selected based upon the quantity of analytics data received for the one or more advertisements within the group of advertisements.

9. The method of claim 1 wherein a selected normalizing algorithm comprises an algorithm selected based upon the one or more advertising metrics to be normalized for the one or more advertisements within the group of advertisements.

10. The method of claim 1 wherein normalizing the analytics data corresponding to the one or more advertising metrics for the one or more advertisements comprises normalizing the analytics data with respect to time.

11. The method of claim 1 wherein normalizing the analytics data corresponding to the one or more advertising metrics for the one or more advertisements comprises normalizing the analytics data with respect to the position of the one or more advertisements in a ranked list of advertisements.

12. The method of claim 1 wherein normalizing the analytics data corresponding to the one or more advertising metrics for the one or more advertisements comprises normalizing the analytics data using an empirical body of data.

13. The method of claim 12 wherein an empirical body of data comprises data indicating the likelihood of an occurrence of an event associated with a given advertising metric.

14. The method of claim 12 wherein an empirical body of data comprises data indicating the likelihood of an occurrence of an event associated with a given advertising metric for one or more advertisements other than the one or more advertisements in the group of advertisements.

15. The method of claim 1 wherein calculating one or more normalized advertising metric values for the one or more advertisements comprises calculating one or more normalized advertising metric values using the normalized analytics data corresponding to one or more advertising metrics.

16. The method of claim 1 comprising:
selecting one or more advertisements from among the group of advertisements for distribution according to one or more normalized advertising metric values associated with the one or more advertisements; and
distributing the one or more selected advertisements.

17. The method of claim 16 wherein selecting one or more advertisements for distribution comprises selecting one or more advertisements with one or more normalized advertising metric values exceeding a given threshold.

18. The method of claim 16 wherein selecting one or more advertisements for distribution comprises generating tracking codes for the one or more advertisements selected that provide analytics data that correspond to the one or more advertising metrics.

19. The method of claim 16 wherein distributing comprises distributing to a website.

20. The method of claim 16 wherein distributing comprises distributing in response to a user search request.

21. The method of claim 16 wherein distributing comprises distributing as one or more pop-up advertisements.

22. The method of claim 16 wherein distributing comprises distributing as one or more banner advertisements.

23. The method of claim 16 wherein distributing comprises distributing to one or more advertisement providers.

24. A system for normalizing analytics data corresponding to one or more advertising metrics for one or more advertisements, the system comprising:
a content data store operative to store one or more advertisements;
an analytics data store operative to store analytics data associated with the one or more advertisements stored in the content data store; and
a normalizing component operative to:
retrieve analytics data corresponding to one or more advertising metrics for the one or more advertisements in the content data store,
normalize the analytics data corresponding to the one or more advertising metrics for the one or more advertisements according to a selected normalizing algorithm, and
calculate one or more normalized advertising metric values for the one or more advertisements.

25. The system of claim 24 wherein the content data store is operative to store one or more advertisements in one or more groups.

26. The system of claim 25 wherein a group of advertisements comprises one or more advertisements directed at selling a similar product or service.

27. The system of claim 25 wherein a group of advertisements comprises one or more advertisements associated with a given advertiser.

28. The system of claim 24 wherein the analytics data store is operative to store analytics data associated with one or more advertising metrics.

29. The system of claim 24 wherein the normalizing component is operative to calculate one or more normalized advertising metric values for a given advertisement using the analytics data associated with the advertisement and the normalizing algorithm selected.

30. The system of claim 24 wherein the normalizing component is operative to calculate one or more normalized advertising metric values for a given advertisement using the normalizing algorithm selected and an empirical body of data.

31. The system of claim 30 wherein an empirical body of data comprises data indicating the likelihood of an occurrence of an event associated with a given advertising metric.

32. The system of claim 30 wherein an empirical body of data comprises data indicating the likelihood of an occurrence of an event associated with a given advertising metric for one or more advertisements other than the one or more advertisements in a given group of advertisements.

33. The system of claim 24 comprising a content distribution component operative to:
select one or more of the advertisements for distribution;
generate tracking codes that identify analytics data corresponding to one or more advertising metrics for the one or more advertisements selected for distribution; and
distribute the one or more advertisements selected for distribution with associated tracking codes.

34. The system of claim 33 wherein the content distribution component is operative to select one or more advertisements for distribution based upon one or more normalized advertising metric values.

35. The system of claim 33 wherein the content distribution component is operative to distribute one or more advertisements with associated tracking codes to one or more web sites.

36. The system of claim 33 wherein the content distribution component is operative to distribute one or more advertisements with associated tracking codes as pop-up advertisements.

37. The system of claim 33 wherein the content distribution component is operative to distribute one or more advertisements with associated tracking codes in response to one or more user search requests.

38. The system of claim 33 wherein the content distribution component is operative to distribute one or more advertisements with associated tracking codes to one or more advertisement providers.
